(19) United States
(12) Patent Application Publication
(10) Pub. No.: US 2017/0008225 A1
(43) Pub. Date: Jan. 12, 2017

(54) AN INDUCTION HEATING DEVICE

(71) Applicant: TETRA LAVAL HOLDINGS & FINANCE S.A., Pully (CH)

(72) Inventors: Bernt LARSSON, Bjärred (SE); Rune CARLSSON, Bjärred (SE)

(73) Assignee: TETRA LAVAL HOLDINGS & FINANCE S.A., Pully (CH)

(21) Appl. No.: 15/039,724

(22) PCT Filed: Nov. 26, 2014
(86) PCT No.: PCT/EP2014/075652

§ 371 Date: May 26, 2016

(30) Foreign Application Priority Data
Nov. 29, 2013 (SE) 1351420-3

(51) Int. Cl. B29C 65/00; H05B 6/10; B29C 65/36; B65B 51/26; B65B 51/22

(52) U.S. Cl. CPC B29C 66/006; B65B 51/26; B65B 51/227; B29C 65/368; B29C 65/3656; B29C 65/3668; B29C 66/1122; B29C 66/4322; B29C 66/4722; B29C 66/72321; B29C 66/72328; B29C 66/8181; B29C 66/8341; B29C 66/849; B29C 66/91651; H05B 6/10; B29K 2995/0008; B29K 2995/0005

(57) ABSTRACT

An induction heating device having two superimposed conductors is provided, comprising a first conductor having a first electrically conducting pattern; a second conductor having a second electrically conducting pattern; wherein the first electrically conducting pattern and the second electrically conducting pattern are: i) connected to an alternating current in use; ii) superimposed thereby resulting in at least one section where the first electrically conducting pattern overlaps the second electrically conducting pattern; and iii) separated by at least a space arranged for accommodating material with an electrically conducting layer, wherein when the alternating current is supplied, the alternating current in the first electrically conducting pattern in a specific section has the same direction as the alternating current of the second electrically conducting pattern in said section.

### TECHNICAL FIELD

The present invention relates to an induction heating device. Particularly the present invention relates to an induction heating device and a method for securely laminating a longitudinal strip to a web of carton-based packaging material.

### BACKGROUND

In liquid product packaging, e.g. in liquid food packaging, a carton-based packaging material is often used for forming the final packages. FIG. 1 shows an example of such a system, i.e. a general setup of a filling machine 1 used for filling liquid food product into individual carton-based packages. The packaging material may be provided as single sheets for creating individual packages in a filling machine, or as a web of material 2 which is fed into a filling machine as is shown in FIG. 1. The web of packaging material 2 is normally distributed in large rolls 3 of which the filling machine is configured to feed the packaging material 2 through various treatment stations, such as sterilizers, forming sections 4, filling sections 5, and distribution sections of the filling machine.

The packaging material 2 may be formed into an open ended tube 6. The tube 6 is arranged vertically in the filling machine 1 and is subject to continuous filling as the packaging material is transported through the filling machine. As the packaging material 2, and thus the tube 6, is moving transversal seals are provided for forming individual packages of the tube. Each package is separated from the tube by a sealing jaw system 7 operating to provide a transversal seal and a corresponding cut in the sealing area, and the individual packages 8 are transported for allowing subsequent packages to be separated from the tube.

The tube 6 is formed by arranging the lateral ends of the packaging material such that they overlap, and by sealing the lateral ends to each other for creating a fluid tight connection between the lateral ends. However, such overlapping will allow one of the lateral ends of the packaging material to be exposed to the liquid product within the tube. Such exposure may lead to unwanted contamination of the liquid as well as degradation of the packaging container as the carton layer may absorb some of the liquid enclosed within the packaging container. It is therefore preferred to provide one of the lateral ends, and particularly the lateral end which later will be arranged on the inside of the tube, with a longitudinal strip of polymeric material. When the lateral ends are sealed the longitudinal strip will be laminated to the inner sides of both lateral ends; thus forming a fluid tight protection for preventing the carton layer to be exposed to the liquid product inside the packaging container.

The longitudinal strip may be attached to the carton based material by laminating the polymeric strip to the inner side of the packaging material, i.e. the side which will form the interior side of the liquid product packaging container. The longitudinal strip is positioned such that it extends laterally outside the web of packaging material; in that way the longitudinal strip will also extend over the opposite lateral end of the packaging material when the tube is formed.

One way of laminating the longitudinal strip to the packaging material is by induction heating, a well established heating technology which requires the provision of a conductive layer within the packaging material. For many packages a thin layer of aluminum is provided for creating an aseptic barrier in the packaging material. Hence, by generating an electrical field close to the aluminum layer by means of an induction heating device, eddy currents are formed within the aluminum layer. Due to the intrinsic resistance in the aluminum the eddy currents will generate heat used for melting the polymers of the packaging material as well as of the longitudinal strip. By arranging the longitudinal strip against the packaging material during heating the longitudinal strip will be laminated to the packaging material.

When a roll of packaging material is running empty splicing is necessary in order to prevent downtime. At the longitudinal position of the splice two layers of packaging material will be stacked onto each other across the entire width of the packaging material web. When the longitudinal strip is laminated the induction heating device used for inducing the eddy currents will be provided close to the longitudinal strip and the packaging material web. As the packaging material web will be stacked onto each other at the splice, the aluminum foil of one of the layers will not be in contact with the aluminum foil of the other layer. Since the aluminum foils of the two layers are not in contact with each other the heat induced by the eddy currents will be discontinuous over the two layers when the induction heating device is arranged across the splice. Accordingly, the induced heat tends to deflect such that heat is generated in a horizontal direction, i.e. in a direction being substantially perpendicular to the longitudinal extension of the longitudinal strip. Following this, a part of the aluminum foil of the new layer of packaging material may not receive the desired amount of heat. Commonly, this issue may be addressed by increasing the current in the induction heating device for assuring that enough heating is provided also to the new layer of packaging material. However, it is important to accurately monitor the heating process due to increased current in order to prevent damage or burning of the packaging material as a result from over-heating.

An improved solution for inducing heat to a packaging material web would be therefore advantageous, and in particular for attaching a longitudinal strip to a packaging material web.

### SUMMARY

It is, therefore, an object of the present invention to overcome or alleviate the above described problems.

An idea of the present invention is to provide an induction heating device which provides several local magnetic fields instead of one continuous magnetic field.

According to a first aspect an induction heating device for heating a material with an electrically conducting layer is provided. The induction heating device comprises a first conductor comprising a first electrically conducting pattern; a second conductor comprising a second electrically conducting pattern; wherein the first electrically conducting pattern and the second electrically conducting pattern are: i) connected to an alternating current in use; ii) superimposed thereby resulting in at least one section where the first electrically conducting pattern overlaps the second electrically conducting pattern; and iii) separated by at least a space arranged for accommodating material with an electrically conducting layer, wherein when the alternating current is supplied, the alternating current in the first electrically conducting pattern in a specific section has the same direction as the alternating current of the second electrically conducting pattern in said section.

The first conducting pattern may be arranged to allow the alternating current to flow from a first end to a second end thereof, and the second electrically conducting pattern is arranged to allow the alternating current to flow from a first end to a second end thereof.

The second end of the first electrically conducting pattern may be electrically connected to the first end of the second electrically conducting pattern.

The first conductor may further comprise at least one cooling element being connected to the first electrically conducting pattern, and the second conductor may further comprise at least one cooling element being connected to the second electrically conducting pattern.

The first conductor may further comprise a support to which the first electrically conducting pattern is connected, and the second conductor may further comprise a support to which the second electrically conducting pattern is connected.

The first conductor and/or the second conductor may further comprise a magnetic insert.

The first electrically conducting pattern and/or the second electrically conducting pattern may be square wave shaped. In another embodiment, the first electrically conducting pattern and/or the second electrically conducting pattern may be saw tooth shaped.

The induction heating device may further comprise at least two sections where the first electrically conducting pattern overlaps the second electrically conducting pattern, and wherein two adjacent section are separated by a conductor section for which the first electrically conducting pattern has an opposite direction as the alternating current of the second electrically conducting pattern.

The induction heating device may have a first operation mode, wherein the alternating current is supplied in pulses, and a second operation mode, in which the alternating current is continuously supplied.

According to a second aspect, a filling machine for providing carton-based packages enclosing liquid product is provided. The filling machine may comprise at least one induction heating device according to the first aspect for attaching a longitudinal strip of polymeric material to a lateral end of a carton-based packaging material.

According to a third aspect a method for attaching a longitudinal strip of polymeric material to a lateral end of a carton-based packaging material including a layer of aluminum is provided. The method comprises the steps of: aligning said longitudinal strip with said packaging material in a space of an induction heating device according to the first aspect, providing an alternating electrical current through the first and second conductors of said induction heating device for generating eddy currents in the aluminum layer of said packaging material thus heating the longitudinal strip and the packaging material, and pressing said longitudinal strip against said packaging material for laminating said longitudinal strip to said packaging material.

### BRIEF DESCRIPTION OF DRAWINGS

The above, as well as additional objects, features, and advantages of the present invention, will be better understood through the following illustrative and non-limiting detailed description of preferred embodiments of the present invention, with reference to the appended drawings, wherein:

FIG. 1 is a schematic view of a filling machine according to prior art;

FIG. 2 is a schematic view of two conductors of an induction heating device according to an embodiment;

FIG. 3 is a schematic view of two superimposed conductors of an induction heating device according to an embodiment;

FIG. 4 is an exploded view of a first conductor of an induction heating device according to an embodiment;

FIG. 5 is an exploded view of a second conductor of an induction heating device according to an embodiment;

FIG. 6 is a schematic view of an induction heating device according to an embodiment;

FIG. 7a is a schematic view of two conductors of an induction heating device according to an embodiment; and

FIG. 7b is a schematic view of two superimposed conductors of an induction heating device according to an embodiment.

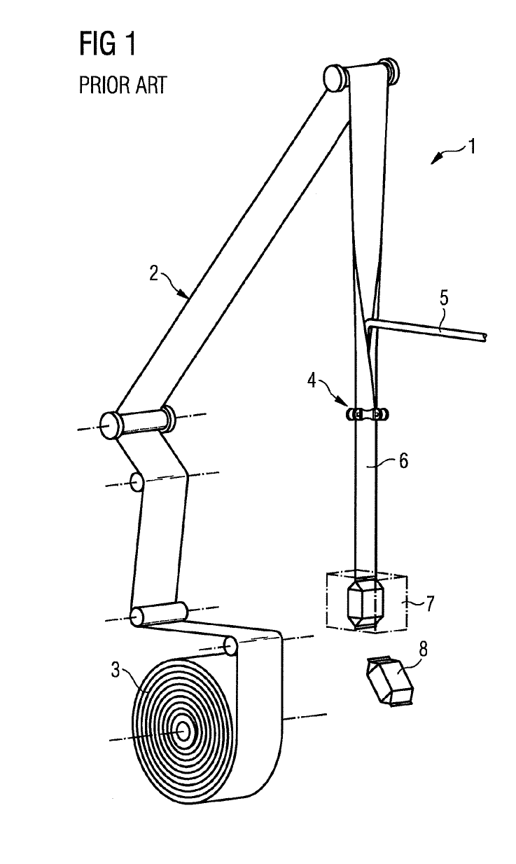

### DETAILED DESCRIPTION

A basic idea is to provide an induction heating device comprising mainly two parts, each comprising an electrically conducting pattern through which an alternating electric current (I) is supplied. The first part may be referred to as a first conductor, and the second part may be referred to as a second conductor throughout this specification.

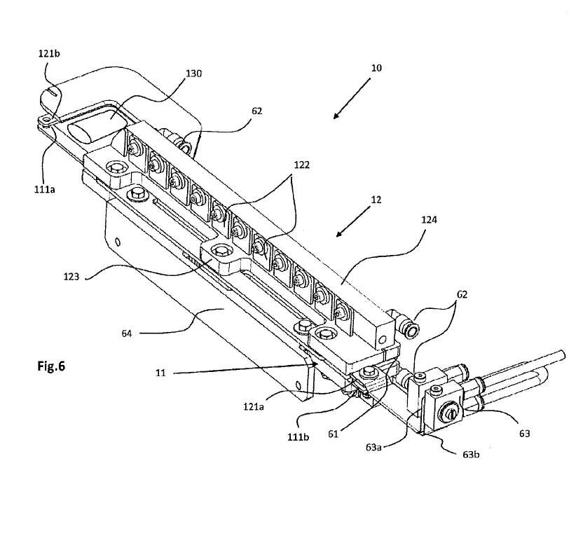

The two parts are preferably arranged in parallel and they are separated by a distance along at least portion thereof, and the electrically conducting patterns are superimposed. The distance creates a space 61 (see FIG. 6) in which the packaging material(s) may move in operation. Electric current is supplied to the first conductor, whereby it travels in a general first direction along the electrically conducting pattern from a start point to end point thereof. When the two conducting patterns are electrically connected the electric current leaving the first conductor at the end point thereof may enter a start point of the second electrically conducting pattern. The electric current then flows between the start point and end point of the second electrically conducting pattern in a general direction opposite to that of the first direction. Since the two electrically conducting patterns are superimposed, the current running along the electrically conducting patterns will generate a number of local magnetic fields. For superimposed sections where the current direction of the first conducting pattern is opposite to that of the second conducting pattern, the resulting magnetic field will be essentially zero or close thereto. However, for superimposed sections where the current direction of the first conducting pattern is essentially the same as that of the second conducting pattern, the generated magnetic field will be increased. This leads to a distribution of local magnetic fields achieved by a single induction heating device. The local magnetic fields have shown to produce eddy currents creating small heated spots to the packaging material web. Since the packaging material web is moving it will create a controlled line of heated area. Furthermore, due to the relative position of the first conductor, the moving packaging material and the second conductor the eddy currents will be generated in small isolated areas, whereby the generated heat will follow the packaging material web edge even though the aluminium foil is cut as in the packaging material splice. This relative configuration drastically reduces the above mentioned deflection whereby the longitudinal strip may be adequately laminated without increased current, even at a packaging material splice.

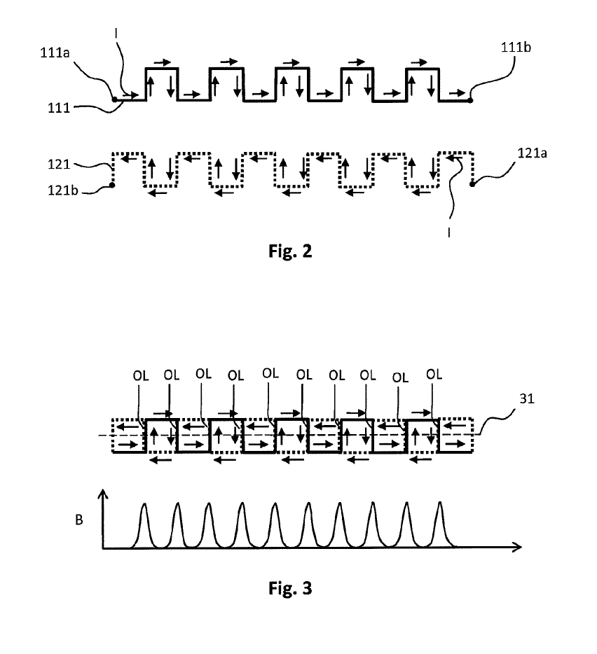

FIG. 2 illustrates schematically a first conducting pattern 111 and a second conducting pattern 121 of an induction heating device, i.e. the first and second conductors. An alternating electric current I is supplied to a start point 111a of the first conducting pattern 111 at the top portion of FIG. 2. The electric current flows through the conducting pattern 111 until an end point 111b thereof along the arrows as identified in FIG. 2. The bottom portion of FIG. 2 illustrates a second conducting pattern 121. The electric current I flows from a start point 121a of the second conducting pattern to and end point 121b of the second conducting pattern. The end point 111b of the first conducting pattern may in some embodiments be connected to the start point 121a of the second conducting pattern. However, it should be appreciated that electric current may be provided separately to the start point 121a of the second conducting pattern, e.g. from the same current source as that providing the first conducting pattern with current.

FIG. 3 illustrates the second conducting pattern 121 being superimposed on the first conducting pattern 111, whereby the flow of electrical currents in the first and second conducting pattern is indicated by the arrows. Hence, FIG. 3 illustrates the conductors when they are arranged in an induction heating device, whereby the first and second conductors extend in parallel and provides a constant distance between the two conductors for accommodating the packaging material(s) prior to laminating the longitudinal strip.

As may be observed in FIG. 3, there is an overlap OL between the two conducting patterns at some sections along the two superimposed conducting patterns. At these overlaps, the electrical current I flowing in the first conducting layer will have the same direction as the electrical current I flowing in the second conducting layer, resulting in a total current of 2I flowing in the overlapped section, although in different conductors. Hence, at these overlapping sections the magnetic field generated by the electric currents flowing in the two superimposed conducting patterns will be higher than in non overlapping sections. Furthermore, the magnetic field as sensed along a longitudinal axis 31 centrally located between the two superimposed conducting patterns will essentially be based on a zero current, as the current flow directions between the first and second conducting patterns are opposite, for the non overlapping sections. The bottom portion of FIG. 3 shows the generated magnetic fields along the longitudinal axis of the superimposed conducting patterns, seen from the centre line 31. Starting at the left end of the diagram of FIG. 3, the currents flowing in the two conductors 11, 12 will have opposite directions whereby the resulting magnetic field will be essentially zero. The adjacent overlapping area OL will give rise to an increased magnetic field resulting from the two conductors 11, 12 in which the current is flowing in the same directions. Hence, the resulting magnetic field will form several peaks along the centre line 31.

The overlapped OL sections of the two conducting patterns hence give rise to local magnetic fields being greater in magnitude than the magnetic fields being generated in the non-overlapping sections. The increased local magnetic fields around the overlapped sections has been shown to improve the heating of the aluminium foil(s) of the packaging material which moves in the space created between the two superimposed parts of the induction heating device. Accordingly, as the packaging material passes between the two superimposed conducting patterns it will be subject to a number of increased local magnetic fields. Since the increased magnetic field(s) occurs at discrete overlapping sections of the conducting pattern, it is possible to provide sufficient heating to the aluminium foil of the packaging material, while maintaining the operating electric current as low as possible, thereby preventing any undesired over-heating or burning. From a general perspective, the local magnetic fields create small eddies of current in the packaging material, and where the currents are concentrated, heat is generated. The eddy currents used for generating the heat seems to be most concentrated in the areas of the increased local magnetic fields, and to be spread out in the other areas. The exact location of the most concentrated eddy currents is where melting of the plastic occurs.

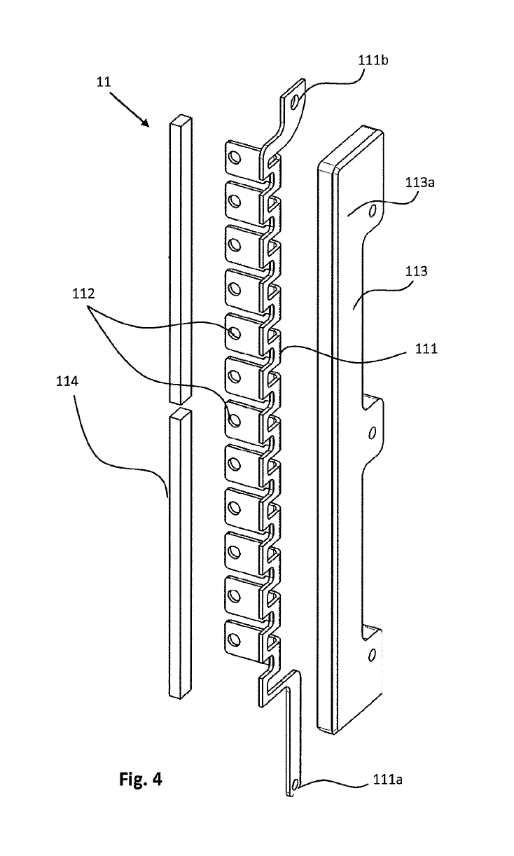

FIG. 4 illustrates an embodiment of the first conductor 11 of an induction heating device 10. The first conductor 11 comprises a first electrically conducting pattern 111. The first conducting pattern may optionally comprise a number of cooling elements 112, such as heat sinks, which are in contact with the conducting pattern 111 for cooling the entire conductor 11. Reducing the temperature of the cooling elements 112 by a cooling fluid may provide efficient cooling of the induction heating device 10 in use.

The conducting pattern 111 is mounted on a support 113. The support 113 is preferably a rigid body of polymeric material, whereby the first conductor 11 is embedded in the rigid body 113 during an injection molding process.

In use, the packaging material is arranged to run adjacent to a surface 113a of the support 113. Further, magnetic inserts 114 may be provided within the support 113 in order to enhance the magnetic field generated by the first conducting pattern 111. The magnetic inserts 114 may preferably be made of ferrotrone or other similar materials used to create an increased magnetic field.

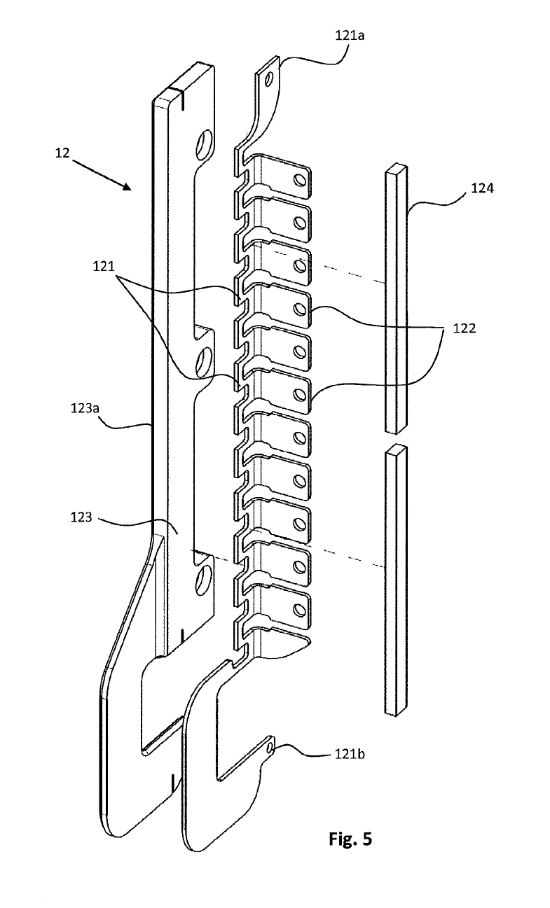

FIG. 5 illustrates an embodiment of the second conductor 12 of the induction heating device 10. The second conductor 12 comprises a second electrically conducting pattern 121. The second conducting pattern may optionally comprise a number of cooling elements 122, such as heat sinks, which are in contact with the conducting pattern 121 for cooling the entire conductor 12. Reducing the temperature of the cooling elements 122 by a cooling fluid may provide efficient cooling of the induction heating device 10 in use.

The conducting pattern 121 is mounted on a support 123 similarly to what has been described with reference to FIG. 4. Further, magnetic inserts 124 may be embedded in the support 123 in order to enhance the magnetic field as has been already described with reference to FIG. 4.

The connector 121b of the second conductor 12 is preferably U-shaped, as indicated by FIG. 5. Such shape is advantageous by the fact that the space formed within the U-shape, i.e. between the legs, may be used to accommodate a roller 130 which is used to align the longitudinal strip relative the induction heating device as well as relative the material web. Further, the shape of the connector 121b prevents superposition of unshielded connectors.

In use, the packaging material is arranged to run adjacent to a surface 123a of the support 123. Hence, when the second conductor is arranged in parallel and at a distance from the first conductor 11, the surfaces 123a and 113a are facing each other whereby the material web is arranged between the surfaces 123a, 113a.

FIG. 6 illustrates an induction heating device 10 according to an embodiment.

The induction heating device 10 comprises the first conductor 11 and the second conductor 12 being mounted together, such as to form a space 61 there between in which the packaging material may travel during operation. Hence, the space 61 extends along the length of the first and second conductors 11, 12, i.e. in their longitudinal direction.

The two conducting patterns of the first conductor 11 and second conductor 12 are superimposed in the mounted state in order to provide local magnetic fields in accordance with the description above. As may be observed from FIG. 6, a cooling block 125 of the second conductor comprises a channel (not shown) for cooling fluid, such as water, air, etc. A similar cooling block may be provided for the first conductor 11, although not being shown in FIG. 6. Each of the cooling blocks 125 may be provided with a channel for transporting cooling fluid. The cooling channels (not shown) may be connected to a number of cooling fluid connectors 62 acting to connect the cooling blocks to a source of cooling fluid. In use, the cooling fluid is pumped through the cooling blocks thereby removing heat from the first and second conducting pattern, which otherwise could lead to overheating of the induction heating device 10.

Cooling is also provided to the electrical connectors 63a, 63b. The electrical connector 63a is connected to a power supply and the second conductor 12, while connector 63b is connected to the power supply and the first conductor 11. Each connector 63a, 63b includes a housing for allowing cooling fluid to flow therethrough. As can be seen in FIG. 6 the end point 121b of the second conductor 12 is connected to the start point 11a of the first conductor, thus creating an electrical circuit. A support 64 is fixedly attached to the first conductor 11, which support 64 is used to secure the induction heating device 10 to a filling machine by screws, bolts, or similar.

In an embodiment the first and/or second electrically conducting pattern is square-wave shaped along a longitudinal axis thereof, as may be observed in FIGS. 2 and 3. The longitudinal axis is parallel to the direction of movement of the packaging material and longitudinal strip in use. When superimposed and supplied with an alternating electrical current the overlapping sections of the two conducting patterns will be directed transversely in relation to the longitudinal axis. Hence, the sections at which the electric current of the first conducting pattern have the same direction as the second conducting pattern will be arranged transversely to the direction of movement of the packaging material and longitudinal strip. By comparison, in current induction heating device solutions the electrically conducting wire(s) are directed essentially parallel to the longitudinal axis or direction of movement. It may be observed that the local magnetic fields generated at the overlapped sections of the induction heating device according to some embodiments has a direction being rotated 90 degrees in relation to that of the magnetic field as being generated by the commonly used longitudinally arranged conducting wire.

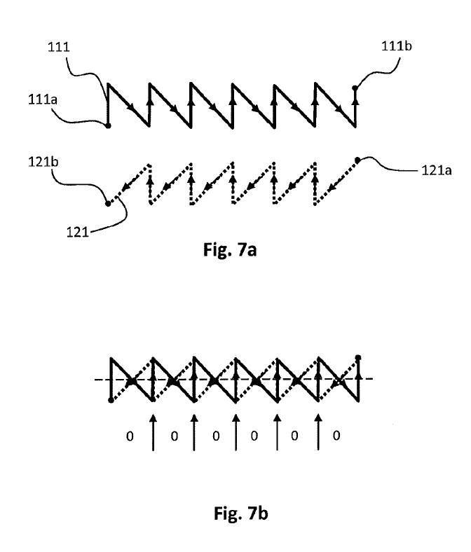

In an embodiment, according to FIG. 7a, the first and/or second electrically conducting pattern is saw tooth shaped. FIG. 7b shows the two conducting patterns being superimposed. Due to the saw-shaped conducting pattern there will be overlapping sections throughout the conducting patterns in which the direction of the current of the first conducting pattern is equal to that of the second conducting pattern.

For this particular saw-shaped conducting pattern the current direction is the same for each overlapping section. This is different to the square-wave shaped conducting pattern as described in view of FIGS. 2 and 3, where the current direction in the overlapped sections change for each overlapping section.

In an embodiment, the electric current is an alternating current. The alternating current may be a pulsed alternating current. A pulsed alternating current may be supplied to the induction heating device in a first operation state, such as a normal operation state wherein no splice is detected. Hence, in the first operation state only one layer of packaging material is travelling between the first conductor 11 and the second conductor 12, whereby the pulsed AC current achieves the proper longitudinal strip sealing. The alternating current may also supplied in a continuous manner, e.g. in a second operation state, where a splice is detected. In this situation two layers of packaging material are travelling between the first conductor 11 and the second conductor 12. The continuous AC current in the second state will increase the sealing effect to assure that the longitudinal strip is adequately sealed even at the splice area. An upcoming splice may be detected by means of a sensor, or by a controller of the filling machine being capable of automatically monitor the packaging material consumption.

By providing the induction heating device with conducting patterns, which results in local increased magnetic fields, it has been proven that it is possible to reduce the required power significantly while still providing a required sealing effect. Accordingly, this allows for a reduced risk of human hazard as well as less impact on the environment.

In accordance with the description above the induction heating device 10 is configured to generate heat in a conductive layer of a packaging material being transported through the induction heating device 10. The heat causes a polymer layer of the packaging material to melt, whereby a longitudinal strip may be laminated to the packaging material immediately after the packaging material exits the induction heating device 10. Due to the provision of small local magnetic fields along the length of the induction heating device 10 the generation of eddy currents in the conductive layer will be distributed accordingly, thus reducing the risk that the generated heat is deflected e.g. at splices.

Although the above description has been made mostly with reference to a induction heating device for sealing a packaging material web, it should be readily understood that the general principle of the method and device is applicable for various different technical fields in which sealing by induction is desired.

Further, the invention has mainly been described with reference to a few embodiments. However, as is readily understood by a person skilled in the art, other embodiments than the ones disclosed above are equally possible within the scope of the invention, as defined by the appended claims.

1. An induction heating device for heating a material with an electrically conducting layer, comprising
a first conductor comprising a first electrically conducting pattern;
a second conductor comprising a second electrically conducting pattern; wherein the first electrically conducting pattern and the second electrically conducting pattern are:
connected to an alternating current in use;
superimposed thereby resulting in at least one section where the first electrically conducting pattern overlaps the second electrically conducting pattern; and
separated by at least a space arranged for accommodating material with an electrically conducting layer,
wherein when the alternating current is supplied, the alternating current in the first electrically conducting pattern in a specific section has the same direction as the alternating current of the second electrically conducting pattern in said section. Page 4

2. The induction heating device according to claim 1, wherein the first conducting pattern is arranged to allow the alternating current to flow from a first end to a second end thereof, and the second electrically conducting pattern is arranged to allow the alternating current to flow from a first end to a second end thereof.

3. The induction heating device according to claim 2, wherein the second end of the first electrically conducting pattern is electrically connected to the first end of the second electrically conducting pattern.

4. The induction heating device according to claim 1, wherein the first conductor further comprises at least one cooling element being connected to the first electrically conducting pattern, and the second conductor further comprises at least one cooling element being connected to the second electrically conducting pattern.

5. The induction heating device according to claim 4, wherein the first conductor further comprises a support to which the first electrically conducting pattern is connected, and the second conductor further comprises a support to which the second electrically conducting pattern is connected.

6. The induction heating device according to claim 4, wherein the first conductor and/or the second conductor further comprises a magnetic insert.

7. The induction heating device according to claim 1, wherein the first electrically conducting pattern and/or the second electrically conducting pattern is square wave shaped.

8. The induction heating device according to claim 1, wherein the first electrically conducting pattern and/or the second electrically conducting pattern is saw tooth shaped.

9. The induction heating device according to claim 1, comprising at least two sections where the first electrically conducting pattern overlaps the second electrically conducting pattern, and wherein two adjacent section are separated by a conductor section for which the first electrically conducting pattern has an opposite direction as the alternating current of the second electrically conducting pattern.

10. The induction heating device according to claim 1, wherein the induction heating device has a first operation mode, wherein the alternating current is supplied in pulses, and a second operation mode, in which the alternating current is continuously supplied.

11. A filling machine for providing carton-based packages enclosing liquid product, comprising at least one induction heating device according to claim 1 for attaching a longitudinal strip of polymeric material to a lateral end of a carton-based packaging material.

12. A method for attaching a longitudinal strip of polymeric material to a lateral end of a carton-based packaging material including a layer of aluminum, comprising the steps of:
aligning said longitudinal strip with said packaging material in a space of an induction heating device according to claim 1,
providing an alternating electrical current through the first and second conductors of said induction heating device for generating eddy currents in the aluminum layer of said packaging material thus heating the longitudinal strip and the packaging material, and
pressing said longitudinal strip against said packaging material for laminating said longitudinal strip to said packaging material.

13. An induction heating device for heating a carton-based packaging material that includes an electrically conducting layer, the induction heating device comprising:
a first conductor comprising a first electrically conducting pattern supported on a first support;
a second conductor comprising a second electrically conducting pattern supported on a second support;
the first and second conductors being mounted relative to one another such that a space exists between the first and second conductors in which the packaging material travels during operation of the induction heating device;
the first electrically conducting pattern including a start point configured to be connected to alternating current in use so that the alternating current flows from the start point at one end of the first electrically conducting pattern to an end point at an opposite end of the first electrically conducting pattern;
the second electrically conducting pattern including a start point configured to be connected to alternating current in use so that the alternating current flows from the start point at one end of the second electrically conducting pattern to an end point at an opposite end of the second electrically conducting pattern; and
the first and second electrically conducting patterns being superimposed on one another so that the first and second electrically conducting patterns each include a plurality of spaced apart sections at which the first electrically conducting pattern overlaps the second electrically conducting pattern so that when the alternating current is supplied to both the first and second electrically conducting patterns, a direction of the alternating current in the spaced apart sections of the first electrically conducting pattern is the same as the direction of the alternating current in the spaced apart sections of the second electrically conducting pattern.

14. The induction heating device according to claim 13, wherein the induction heating device possesses oppositely located first and second ends, the start point of the first conducting pattern being at the first end of the induction heating device, the start point of the second conducting pattern being at the second end of the induction heating device.

15. The induction heating device according to claim 13, the first conductor further comprising at least one cooling element connected to the first electrically conducting pattern, and the second conductor further comprising at least one cooling element connected to the second electrically conducting pattern.

16. The induction heating device according to claim 13, the first conductor further comprising a magnetic insert, and the second conductor further comprising a magnetic insert.

17. The induction heating device according to claim 13, wherein the first electrically conducting pattern is square wave-shaped, and the second electrically conducting pattern is square wave-shaped.

18. The induction heating device according to claim 13, wherein the first electrically conducting pattern is saw tooth-shaped, and the second electrically conducting pattern is saw tooth-shaped.
